(19) United States
(12) Patent Application Publication
(10) Pub. No.: US 2025/0031141 A1
(43) Pub. Date: Jan. 23, 2025

(54) OPTIMIZED CAG CELL SELECTION SIM COMMANDS WITH CAG CELL SELECTION

(71) Applicant: APPLE INC., CUPERTINO, CA (US)

(72) Inventors: Stanley M. MAYALIL, San Jose, CA (US); Anikethan Ramakrishna VIJAYA KUMAR, Mysuru (IN); Rajkumar KRISHNAPERUMAL, Bangalore (IN); Vivek G. GUPTA, San Jose, CA (US); Piush KUMAR, Bangalor (IN); Arjun Ramesh SHETTY, Bangalore (IN); Rajeev VERMA, San Jose, CA (US)

(21) Appl. No.: 18/882,337

(22) Filed: Sep. 11, 2024

Related U.S. Application Data
(63) Continuation of application No. PCT/US2024/037867, filed on Jul. 12, 2024.
(60) Provisional application No. 63/515,049, filed on Jul. 21, 2023.
(60) Provisional application No. 63/592,105, filed on Oct. 20, 2023.

(51) Int. Cl. H04W 48/20; H04W 8/18; H04W 60/04; H04W 84/04

(52) U.S. Cl. CPC H04W 48/20; H04W 8/183; H04W 60/04; H04W 84/042

(57) ABSTRACT

A method performed by a user equipment that is in communication with a network, includes receiving, a CAG information list from the network, the CAG information list including one or more CAG IDs and an association between each of the one or more CAG IDs and one or more NPN PLMN IDs. The method includes receiving, from the network, a network name list including one or more network names and the one or more CAG IDs and an association between each of the one or more network names and the one or more CAG IDs in the CAG information list, selecting a CAG cell as a serving cell based at least on the CAG information list or the network name list, and sending to a SIM of the UE, CAG data based on the CAG information list and the network name list.

### CROSS-REFERENCE TO RELATED APPLICATION

This patent application is a continuation of and claims benefit of International Application No. PCT/US2024/037867, filed Jul. 12, 2024 entitled “OPTIMIZED CAG CELL SELECTION SIM COMMANDS”, U.S. Provisional Patent Application No. 63/592,105, filed Oct. 20, 2023 entitled “OPTIMIZED CAG CELL SELECTION SIM COMMANDS WITH CAG CELL SELECTION” and U.S. Provisional Patent Application No. 63/515,049, filed Jul. 21, 2023 entitled “OPTIMIZED CAG CELL SELECTION SIM COMMANDS”, all of which are herein incorporated by reference in their entirety and for all purposes.

### TECHNICAL FIELD

This disclosure relates generally to wireless technology and more particularly to enhanced SIM commands with respect to CAG cell selection and related data.

### BACKGROUND

Fifth generation mobile network (5G) is a wireless standard that aims to improve upon data transmission speed, reliability, availability, and more. The wireless standard includes numerous procedures that may be implemented by a transmitting device or a receiving device that improves the latency, the speed, and the reliability of uplink and downlink transmissions.

### SUMMARY

Aspects of the present disclosure relate to 5G new radio (NR) operating in the licensed spectrum or in the shared and unlicensed spectrum (NR-U).

In an aspect, a method, performed by a user equipment that is in communication with a network, comprises receiving, a closed access group (CAG) information list from the network, comprising one or more CAG identifiers (IDs) and an association between each of the one or more CAG IDs and one or more non-public networks public land mobile network (NPN PLMN) IDs. The UE receives, from the network, a network name list comprising one or more network names and the one or more CAG IDs and an association between each of the one or more network names and the one or more CAG IDs in the CAG information list. The UE selects a CAG cell as a serving cell based at least on the CAG information list or the network name list. The UE sends to a subscriber identity module (SIM) of the UE, CAG data that the UE generates based on the CAG information list and the network name list.

In an example, sending the CAG data to the SIM comprises sending to the SIM, first data comprising a list of the one or more CAG IDs and a corresponding one of the NPN PLMN IDs, and second data comprising, a list of one of the one or more network names in a same order as an order of the NPN PLMN IDs listed in the first data, wherein each of the one or more NPN PLMN IDs correspond to one of the one or more network names. In an example, the second data does not comprise any of the one or more CAG IDs. In an example, the second data comprises, for each of the one or more network names, a network name tag, a respective length associated with the respective network name tag, and the respective network name, without additional information.

In an example, sending the CAG data to the SIM comprises sending to the SIM, first data comprising a list of one or more CAG IDs and a corresponding one of the NPN PLMN IDs for each of the one or more CAG IDs, and second data comprising a list of each of the one or more NPN PLMN IDs and a corresponding one of the one or more network names. In an example, the second data comprises each of the one or more NPN PLMN IDs paired with the one or more network names, each pair comprising a network name tag, a length associated with the network name, the respective NPN PLMN ID, and the respective network name.

In an example, sending the CAG data to the SIM comprises, in response to determining that the network name list is received, sending to the SIM, second data comprising one or more items, each of the one or more items comprising a respective one of the one or more network names, a respective one of the NPN PLMN IDs that is associated with the respective one of the one or more network names, and each of the one or more CAG IDs that is associated with the respective one of the NPN PLMN IDs, without sending first data comprising a list of the one or more CAG IDs and a corresponding one of the NPN PLMN IDs for each of the one or more CAG IDs. In an example, sending the second data comprises sending a first item of the one or more items, the first item comprising a first tag associated with a single CAG ID, a first length associated with a single CAG ID, a first of the one or more NPN PLMN IDs, a single one of the one or more CAG IDs that is associated with the first of the one or more NPN PLMN IDs, and one of the one or more network names that is associated with the first of the one or more NPN PLMN IDs. In an example, sending the second data comprises sending a second item of the one or more items, the second item comprising a second tag associated with a range of CAG IDs, a second length associated with the range of CAG IDs, a second of the one or more NPN PLMN IDs that is associated with the range of CAG IDs, a first and second of the one or more CAG IDs that indicate the range of CAG IDs that are associated with the second of the one or more NPN PLMN IDS, and a second of the one or more network names that is associated with the second of the one or more NPN PLMN IDs.

In any of the examples or aspects described, sending the CAG data to the SIM comprises sending the selected CAG cell and associated NPN PLMN IDs in front of additional CAG IDs of the one or more CAG IDs, and truncating a total amount of data sent to the SIM to satisfy a threshold data size to the SIM.

In any of the examples or aspects described, sending the CAG data to the SIM is performed by the UE through a terminal response, in response to a provide local information (PLI) request signaled from the SIM.

In any of the examples or aspects described, sending the CAG data to the SIM is performed by the UE through an envelope command in response to detecting an event associated with a change in the CAG IDs.

In any of the examples or aspects described, in response to the UE not selecting the CAG cell to camp on, the UE does send the CAG data to the SIM (e.g., with the first data and/or the second data).

In an aspect, a user equipment (UE) device that is in communication with a network, comprises a processor that is configured to perform the method described above. In an aspect, a base station comprises a transceiver configured to communicate with a user equipment (UE), and a processor communicatively coupled to the transceiver and configured to perform the methods described herein from the perspective of the network. In an aspect, a processor (e.g., a baseband processor) of a UE is configured to perform the methods described herein from the perspective of the UE.

Other technical features may be readily apparent to one skilled in the art from the following figures, descriptions, and claims.

### BRIEF DESCRIPTION OF THE DRAWINGS

In the figures of the accompanying drawings, aspects described are illustrated by way of example and not by limitation.

FIG. 1 illustrates an example wireless communication system, according to an aspect.

FIG. 2 illustrates uplink and downlink communications, according to an aspect.

FIG. 3 illustrates an example block diagram of a user equipment (UE), according to an aspect.

FIG. 4 illustrates an example block diagram of a base station (BS), according to an aspect.

FIG. 5 illustrates an example block diagram of cellular communication circuitry, according to an aspect.

FIG. 6 illustrates an example of a UE and network with respect to CAG cell selection, according to an aspect.

FIG. 7 illustrates an example method for improving CAG cell selection STK commands, according to an aspect.

FIG. 8 illustrates an example method for improving CAG cell selection STK commands with ordered network names, according to an aspect.

FIG. 9 illustrates an example method performed for improving CAG cell selection STK commands with paired network names and NPN PLMN IDs, according to an aspect.

FIG. 10 illustrates an example method performed for improving CAG cell selection STK commands with tag-based indication of CAG ID presentation, according to an aspect.

FIG. 11 shows an example of a UE and network with respect to CAG cell selection, according to an aspect.

### DETAILED DESCRIPTION

A method and apparatus of a device that communicates wirelessly with a network (e.g., a 5G network) may obtain CAG cell data from a network and send this to a SIM of the UE in an efficient manner that considers various scenarios. It will be apparent, however, to one skilled in the art, that aspects of the present disclosure may be practiced variations of the specific details described. In other instances, well-known components, structures, and techniques have not been shown in detail in order not to obscure the understanding of this description.

Reference in the specification to “some aspects” or “an aspect” means that a particular feature, structure, or characteristic described in connection with the aspect can be included in at least one aspect of the disclosure. The appearances of the phrase “in some aspects” in various places in the specification do not necessarily all refer to the same aspect.

In the following description and claims, the terms “coupled” and “connected,” along with their derivatives, may be used. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

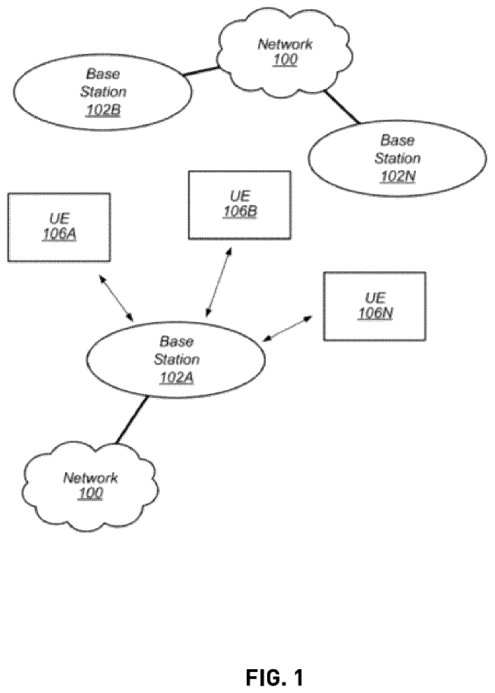

FIG. 1 illustrates a simplified example of a wireless communication system, according to some aspects. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to as a “user equipment” (UE).

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some aspects, base station 102A may be a next generation base station, e.g., a 5G New Radio (5G NR) base station, or “gNB”. In some aspects, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, CHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

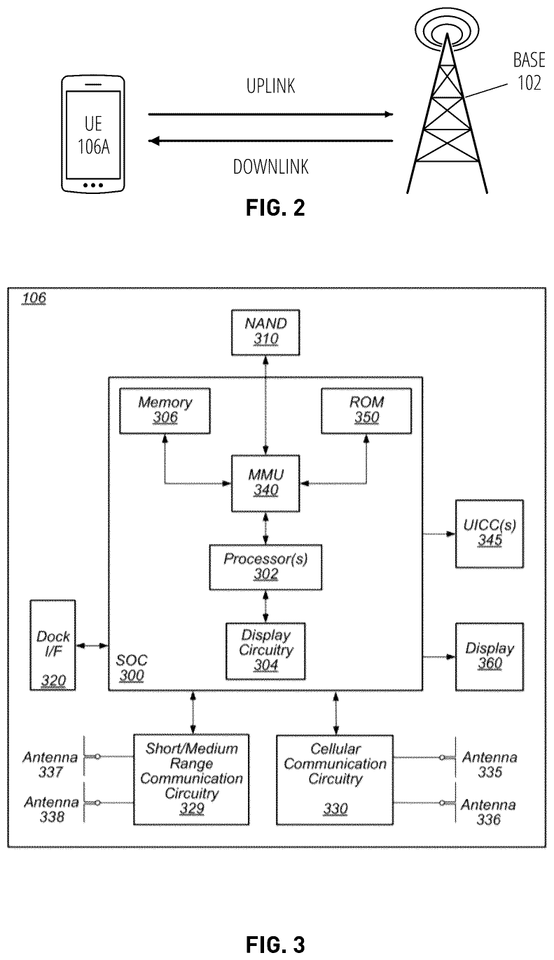

FIG. 2 illustrates UE 106A that can be in communication with a base station 102 through uplink and downlink communications, according to some aspects. The UEs may each be a device with cellular communication capability such as a mobile phone, a hand-held device, a computer or a tablet, or virtually any type of wireless device.

The UE may include a processor that is configured to execute program instructions stored in memory. The UE may perform any of the method aspects described herein by executing such stored instructions. Alternatively, or in addition, the UE may include a programmable hardware element such as an FPGA (field-programmable gate array) that is configured to perform any of the method aspects described herein, or any portion of any of the method aspects described herein.

The UE may include one or more antennas for communicating using one or more wireless communication protocols or technologies. In some aspects, the UE may be configured to communicate using, for example, CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE may include separate transmit and/or receive chains (e.g., including separate antennas and other radio components) for each wireless communication protocol with which it is configured to communicate. As a further possibility, the UE may include one or more radios which are shared between multiple wireless communication protocols, and one or more radios which are used exclusively by a single wireless communication protocol. For example, the UE might include a shared radio for communicating using either of LTE or 5G NR (or LTE or 1×RTT or LTE or GSM), and separate radios for communicating using each of Wi-Fi and Bluetooth. Other configurations are also possible.

FIG. 3 illustrates an example simplified block diagram of a communication device 106, according to some aspects. It is noted that the block diagram of the communication device of FIG. 3 is only one example of a possible communication device. According to aspects, communication device 106 may be a UE device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some aspects, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some aspects, as further described below, cellular communication circuitry 330 may include dedicated receive chains (including and/or coupled to, e.g., communicatively; directly or indirectly. dedicated processors and/or radios) for multiple radio access technologies (RATs) (e.g., a first receive chain for LTE and a second receive chain for 5G NR). In addition, in some aspects, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some aspects, the MMU 340 may be included as a portion of the processor(s) 302.

As noted above, the communication device 106 may be configured to communicate using wireless and/or wired communication circuitry. The communication device 106 may also be configured to determine a physical downlink shared channel scheduling resource for a user equipment device and a base station. Further, the communication device 106 may be configured to group and select CCs from the wireless link and determine a virtual CC from the group of selected CCs. The wireless device may also be configured to perform a physical downlink resource mapping based on an aggregate resource matching patterns of groups of CCs.

As described herein, the communication device 106 may include hardware and software components for implementing the above features for determining a physical downlink shared channel scheduling resource for a communications device 106 and a base station. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short-range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short-range wireless communication circuitry 329 may include one or more ICs that are configured to perform the functions of short-range wireless communication circuitry 32. In addition, each integrated circuit may include circuitry (e.g., first circuitry, second circuitry, etc.) configured to perform the functions of short-range wireless communication circuitry 329.

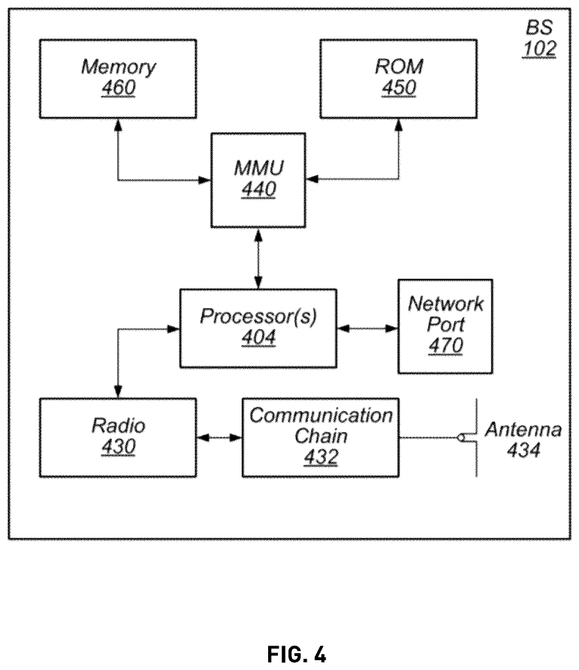

FIG. 4 illustrates an example block diagram of a base station 102, according to some aspects. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some aspects, base station 102 may be a next generation base station, e.g., a 5G New Radio (5G NR) base station, or “gNB”. In such aspects, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs. In some aspects, the base station can operate in 5G NR-U mode.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, 5G NR-U, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR and 5G NR-U. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

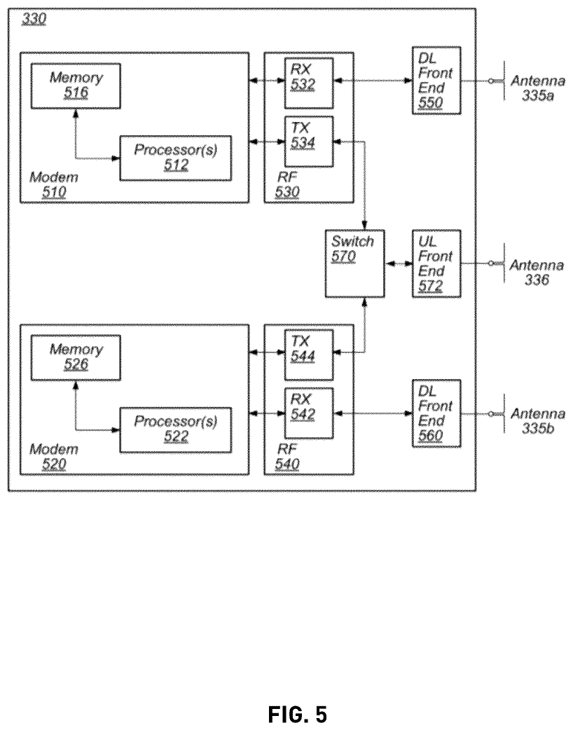

FIG. 5 illustrates an example simplified block diagram of cellular communication circuitry, according to some aspects. It is noted that the block diagram of the cellular communication circuitry of FIG. 5 is only one example of a possible cellular communication circuit. According to aspects, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335 a-b and 336 as shown (in FIG. 3). In some aspects, cellular communication circuitry 330 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some aspects, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some aspects, receive circuitry 542 may be in communication with DL front end 560, which may include circuitry for receiving radio signals via antenna 335b.

In some aspects, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for determining a physical downlink shared channel scheduling resource for a user equipment device and a base station, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for determining a physical downlink shared channel scheduling resource for a user equipment device and a base station, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

5G (also referred to as new radio) supports multi-antenna transmission, beam-forming, and simultaneous transmission from multiple geographically separates sites. 5G physical channels provide flexible communication between the 5G base stations and the UEs. 5G NR has specified the physical channels for 5G networks that can be used either for Downlink or Uplink communication. 5G NR physical channels used for uplink communication includes the physical uplink shared channel (PUSCH), the physical uplink control channel (PUCCH), and the physical random-access channel (PRACH). Reference signals such as demodulation reference signal DM-RS, phase tracking reference signal (PT-RS), and sounding reference signal (SRS) may be transmitted by the network or UE so that the receiving party may measure various qualities relating to the transmitter and adjust a network functionality accordingly. 5G NR supports the simultaneous transmission on PUSCH and PUCCH. PUSCH is typically used to carry the user data and optionally, can carry uplink control information (UCI).

PDSCH stands for Physical Downlink Shared Channel and is a channel used to deliver data from the base station (e.g., gNb) to the user equipment (UE) in the downlink direction. PDSCH supports high data rates and low latency for a wide range of applications and services. It uses advanced modulation and coding schemes, as well as multiple antenna techniques such as MIMO (Multiple Input Multiple Output), to maximize spectral efficiency and improve the overall performance of the network. PDSCH is also used in conjunction with other channels, such as the Physical Downlink Control Channel (PDCCH) and Physical Hybrid ARQ Indicator Channel (PHICH), to support features such as channel state information reporting, scheduling and retransmission of data packets, and HARQ (Hybrid Automatic Repeat Request) feedback. PDSCH enables the delivery of high-speed data and low-latency services to users in the downlink direction, and supports a range of advanced features and capabilities that promote efficient and reliable operation of the network.

Radio Resource Control (RRC) is a protocol layer that exists between the radio access network (RAN) and the core network in 5G. RRC is used to manage radio resources, including the establishment, maintenance, and release of radio connections between the user equipment (UE) and the base station. The RRC protocol performs several essential functions including connection establishment, connection maintenance, and connection release. RRC handles the procedures for establishing a connection between the UE and the base station. This includes procedures such as random access, initial cell search, and authentication. Once a connection is established, RRC is responsible for maintaining the connection and managing the radio resources efficiently. It ensures the appropriate quality of service (QOS) for the UE and handles mobility-related events, such as handovers between cells or handovers between different types of 5G networks (e.g., from 5G New Radio to 5G Core). When the UE no longer needs the connection or if there are other reasons for releasing it, RRC handles the procedures for releasing the connection and freeing up the associated radio resources. The RRC protocol operates on top of the physical layer and the medium access control (MAC) layer in the protocol stack. It communicates with other layers in the 5G system, such as the packet data convergence protocol (PDCP), radio link control (RLC), and the user plane, to support efficient and reliable communication between the UE and the network.

RRC protocol defines several states that a UE can be in. These states determine the level of connectivity and resource allocation between the UE and the network. The RRC states in 5G are RRC_IDLE, RRC_INACTIVE, and RRC_CONNECTED.

In RRC Idle (RRC_IDLE) state, the UE is not actively connected to the network. It is not assigned any dedicated resources, and its radio interface is deactivated. The UE periodically monitors system information broadcasts from the network to stay informed about available cells and other relevant network parameters. When the UE needs to establish a connection or perform a service request, it transitions to a RRC connected state.

When the UE is in RRC inactive (RRC_INACTIVE) state, it has limited 5G resources allocated and uses primarily the LTE network for connectivity. In this state, the UE can quickly transition to the RRC_CONNECTED state when one or more triggering events occur, as defined by one or more standards.

RRC Connected (RRC_CONNECTED) state represents an active connection between the UE and the network. It can be further divided into sub-states:
a. RRC_Connected_Init: The initial sub-state where the UE has just established an RRC connection with the network.
b. RRC_Connected: The UE is in a stable connected state, and it can exchange data and signaling with the network (e.g., over physical uplink and physical downlink channels). It can receive and transmit data, perform handovers, and execute various procedures.
c. RRC_Connected_Reconfiguring: The UE is undergoing a reconfiguration of its RRC connection parameters, such as changing the radio bearer configuration or updating network configuration information.
d. RRC_Connected_Suspend: The UE temporarily suspends its RRC connection while maintaining radio resources for a specified period. It is typically used in power-saving scenarios to conserve energy.
e. RRC_Connected_Release: The UE is releasing its RRC connection, terminating the active connection with the network.

Each RRC state has its own specific behaviors performed by the UE and network which results in specific power consumption characteristics and signaling procedures for the state (or sub-state). The network and the UE manage RRC state transitions based on numerous factors such as network conditions, service requirements, mobility, and power optimization.

Public Land Mobile Network (PLMN) identifier (ID) is a mobile operator's cellular network in a specific country. Each PLMN ID has a unique PLMN code that combines an MCC (Mobile Country Code) and the operators' MNC (Mobile Network Code).

A Non-Public Network (NPN) may refer to the framework (e.g., rules, protocols, requirements, etc.) for deploying a private network in 5G. In 5G, private networks (under NPN framework) may be deployed seamlessly either as standalone networks or by integration into a public mobile network. Two main deployment models in NPN include: Standalone Non-Public Network (SNPN), and Public Network Integrated Non-Public Network (PNI-NPN).

SNPN refers to a network that is completely isolated from public networks. In such a case, the gNB, 5G core network (CN) control plane and user plane are typically implemented within the premises of the enterprise.

PNI-NPN can be deployed using RAN sharing. In such a case, the private network shares part of the RAN (including the gNB) with the public network, while other network functions are deployed on the enterprise premises and remain separated from the public network.

A Public Network integrated Non-Public Network (PNI-NPN) is deployed with the support of a PLMN. It is supported using network slices or Closed Access Group (CAG) cells or a combination of both. The PLMN ID identifies the network, and a CAG ID identifies each specific CAG cell. Network selection and reselection is performed based on PLMN ID. Cell selection and reselection, and access control may be performed based on the CAG ID. CAG functionality may be used for PNI-NPNs to prevent UE(s), which are not allowed to access an NPN, from automatically selecting and accessing the associated CAG cells.

Network slicing in 5G lets a user equipment (UE) device connect through a cellular network that provides traffic isolation to the application servers, except for shared radio layers. In a PNI-NPN, network slicing provides private access but does not prevent UEs from trying to access the network in areas where the UE lacks permission to use the network slice allocated for the NPN. In CAGs, public networks offer private network connectivity and may broadcast the CAG ID. Only devices that have access credentials for that CAG ID can latch on to such cells, thus providing access restriction.

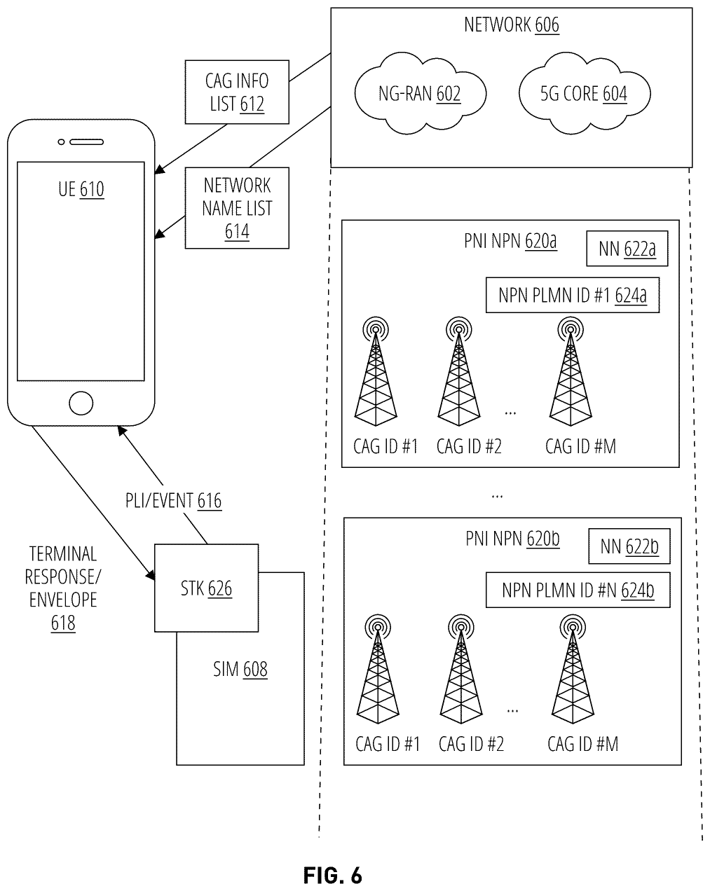

FIG. 6 illustrates an example of a UE and network with respect to CAG cell selection, according to an aspect. A UE 610 may be in communication with a Network 606 which may include next generation radio access network (NG-RAN) 602 and 5G Core 604.

A closed access group (CAG) cell may be a cell that provides private network functionality to one or more UEs. To access a CAG cell, a UE may need to have proper credentials. One or more CAG cells may be part of a respective public network integrated non-public network (PNI-NPN). Network 606 may manage the association between each of the PNI NPNs and their respective CAG cells, by assigning CAG cells in a given PNI PNP with a respective CAG ID. Further, the Network 606 may associate each PNI NPN (e.g., 620a, 620b) with a respective network name (e.g., 622a, 622b), and a respective NPN PLMN ID (e.g., 624a, 624b). Thus, the Network 606 may keep track of which CAG cells belong to each PNI NPN.

The Network 606 may provide a CAG info list 612 and to a UE 610. The CAG information list 612 may include a PNI NPN identity comprising the NPN PLMN ID #and CAG ID #combination for each PNI NPN. The CAG information list 612 may include N number of NPN PLMN IDs (e.g., 624a, 624b), and up to M number of CAG IDs associated with the each of the respective NPN/PLMN IDs. The Network 606 may provide the CAG info list 612 in system information block #1 (SIB #1) to UE 610.

Additionally, Network 606 may provide network name list 614 to UE 610. This may include an entry of the network name for each of the CAG IDs named in CAG info list 612. The Network 606 may provide the network name list 614 in SIB #10. The network name list 614 may include each of the network names 622a-622b which may be ordered such that listed nth network name corresponds to the nth PNI-NPN received previously in CAG info list 612 (e.g., through SIB #1). Each network name may also be referred to as a human readable network name (HRNN). The network name may include a series of symbols (e.g., letters, numbers, other symbols) that is different from the corresponding NPN PLMN ID of that PNI NPN. Given the one to one relationship between network names and NPN PLMN IDs, however, this data may be redundant.

UE 610 may examine the CAG info list 612 and network name list 614 to determine if the UE has access to one of more of the CAG IDs. The UE 610 may select one of the CAG cells (associated with CAG info list 612) that the UE has access to, based on one or more network conditions (e.g., signal strength, signal quality, bandwidth availability, etc.).

An example of a single CAG ID #may be, for example, a 32 bit—“0000 . . . 01”. An example of an NPN PLMN ID may include 3 bytes comprising the mobile country code and mobile network code (MCC/MNC)—“001.011”. An example of a network name may be a string of characters (e.g., ASCII characters) such as: “NetworkA”.

In some cases, the network operator may also provision the CAG info list 612 (e.g., the CAG information list) and/or network name list 614 in subscriber identity module (SIM) 608. Additionally, or alternatively, the UE 610 may send CAG data to the SIM 608. The CAG data may be generated by the UE based on the information obtained in CAG info list 612 or network name list 614, or both.

SIM 608 may be referred to as a universal SIM (USIM). The SIM may include an integrated circuit (IC) on a card (e.g., a SIM card) that stores an international mobile subscriber identity (IMSI) number and its related key. The card may be inserted into a SIM port of the UE. The information on the SIM may be used by the network to identify and authenticate subscribers on a given UE device. The physical SIM card may be referred to as a universal integrated circuit card (UICC). Although shown as separate, it should be understood that SIM 608 may be inserted to a port of UE 610 to facilitate electronic communication between UE 610 and SIM 608.

SIM 608 typically behaves like a terminal residing within a terminal (e.g., UE 610), and may execute its own applets (e.g., logic), operating system, and other network related operations. SIM 608 may include a SIM or USIM Application Toolkit (STK) 626 which interfaces with the UE 610 to let SIM 608 initiate actions with the UE 610. STK 626 may include a set of commands programmed into the SIM which define how the SIM should interact with another device (e.g., UE 610) when connected. This enables the SIM to build up an interactive exchange between a network application and the end user and access, or control access to, the network. SIM 608 may utilize the STK 626 to request CAG related information (e.g., 612, 614). Additionally, or alternatively, the SIM may configure the UE 610 to provide this information automatically when one or more conditions are satisfied (e.g., event-based).

SIM 608 may request CAG related information from UE 610 through a ‘provide local information (PLI) command, or through an envelope command that configures UE 610 to provide the CAG related information when an event (e.g., CAG cell selection) occurs.

In the PLI based scenario, UE 610 receives a PLI STK command 616 from SIM 608 requesting CAG related information including the CAG info list 612 and corresponding network name list 614. In response, the UE 610 may send the CAG related information to SIM 608 via a terminal response.

In the event based scenario, UE 610 receives an Event STK command 616 from SIM 608. The event command may specify a given event, such as a CAG cell selection or a different condition or event. The UE may monitor its own status for a given time and, in response to detecting the condition or event being satisfied, the UE sends a response to the SIM 608 with the requested information such as the CAG related information. For example, the UE may send the envelope response 618 to SIM 608 when the UE 610 detects a change in CAG information list, or when the UE selects or camps on a CAG cell. The UE may send the envelope response periodically to the SIM 608.

In either case, if the UE is not camped on a CAG cell or does not select a CAG cell, the UE may provide a reduced CAG information to SIM 608, such as without the list of network names (622a, 622b) and without the CAG info list 612.

Otherwise, the UE 602 may include in terminal response or envelope 618 CAG data generated based on the information from current selected CAG cell and PNI NPN, including the corresponding NPN PLMN ID #for that CAG cell and the network name corresponding to that NPN PLMN ID #.

The UE may process the CAG info list 612 (e.g., the CAG information list) and network name list 614 directly to the SIM 608 to reduce duplication of CAG data in the terminal response/envelope 618 from UE 610 to SIM 608 in both the PLI or event-based scenario.

Due to the potentially numerous CAG ID #s and PNI NPNs, some limitations and ambiguity and cause UE implementation challenges. For example, when SIM 608 sends a PLI 616 request with Qualifier=‘16’ (CAG information list and the corresponding human-readable network name per CAG ID), then content of a Terminal Response 618 can have redundant CAG ID list which may run against the maximum allowed number of bytes (e.g., 255 bytes) in a terminal response and potentially truncate information.

Further, ambiguity of information provided to the SIM 608 may become a problem. Every individual entry of CAG Information list encoding received in CAG info list 612 may include an unwanted byte. This byte holds no meaning for PLI/Envelope CAG response 618 when provided to SIM 608. Further, the need for truncation may lead to mis-prioritized and incomplete data in the response 618. For example, listing the network name for each CAG ID is a waste of resource, as the network name will be same for multiple CAG IDs within a specific PNI NPN.

When UE detects that the network name in SIB10 is available and UE detects the data to provide to UE either in Terminal response (in response to PLI) or Envelope ‘Event-download CAG cell selection’ (in response to CAG cell selection event) is >255 Byte—there is a risk of truncation. Hence, when i) UE detects this risk of truncation or ii) by default, the UE 610 may either a) use existing behavior with existing limitations and simply forward the CA info list 612 and network name list 614 as encoded by Network 606 to SIM 608, or b) modify this data in the response 618 as described in the present disclosure. Under the existing behavior, different UEs may forward the information to SIM 608 differently, because different UE's will (i) order the data accordingly to UE implementation, and be unable to package all the available info in Terminal response or Envelope command from UE to USIM. This has a risk of the UE dropping specific data that USIM applet is expecting in the CAG data. Further, this may lead to fragmented implementation both on USIM and UE side.

By processing the data as described herein, a simple, easily manageable, and consistent implementation on both UE and USIM may be provided. Redundancy of CAG IDs may be avoided. If needed CAG IDs can be specified by the UE either individually or in range, associated with respective PLMN ID and respective network name. UE implementation is simplified—the network name information provided to USIM aligns with TS. 38.331—since the network name is broadcast in SIB 10 for each NPN PLMN ID and not per CAG ID, the provided terminal response or envelope command from UE 610 to SIM 608 shall also be consistent with this.

Additionally, ambiguity is reduced. In the event that the same CAG ID numbers are repeated across two NPN PLMN IDs broadcasted within SIB1, and two PLMN's have different network names, the UE can inform USIM the correct network name for respective NPN PLMN ID. This is difficult under existing implementations which can give misleading information to SIM 608. Finally, with the additional data processing, In the event of a need for truncation (e.g., the response is to be greater than 255 bytes), the UE may prioritize CAG and network name information of the currently selected PNI NPN and CAG ID and list those first in all instances, even if there are multiple PLMNs, CAG IDs, and network names in the CAG info list 612 and network name list 614.

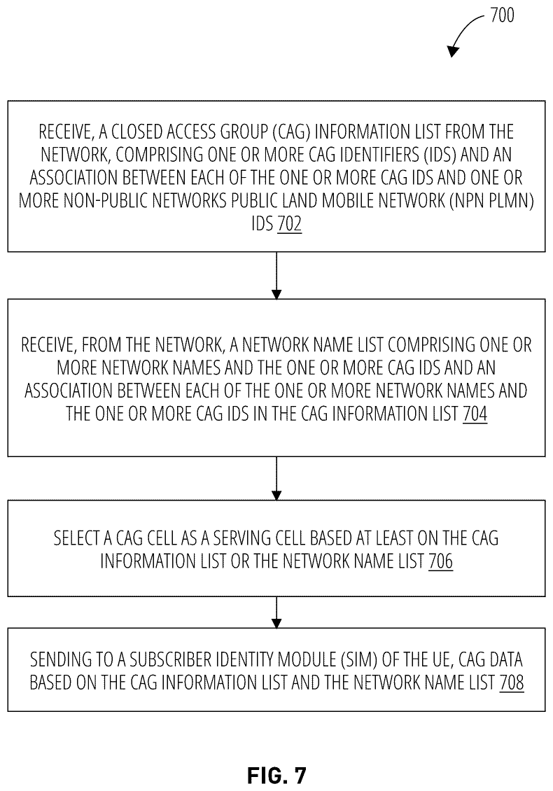

FIG. 7 shows a method performed by a UE to report a result of an AI operation based on internal conditions, in accordance with some aspects. The method 700 may be performed by processing logic of a UE, which may be coupled to a transceiver, where the processor may execute instructions stored on computer-readable memory to perform the method described. The performed by user equipment (UE) in communication with a network.

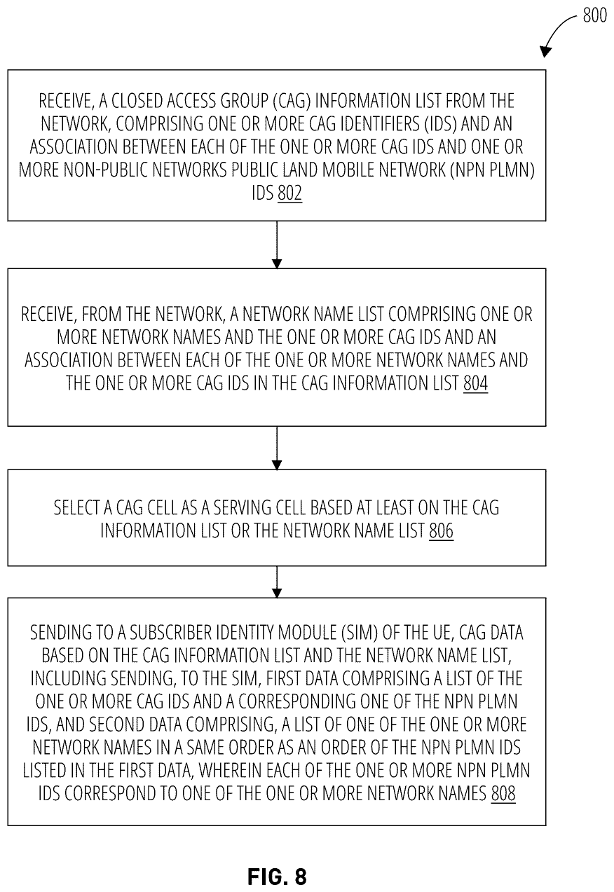

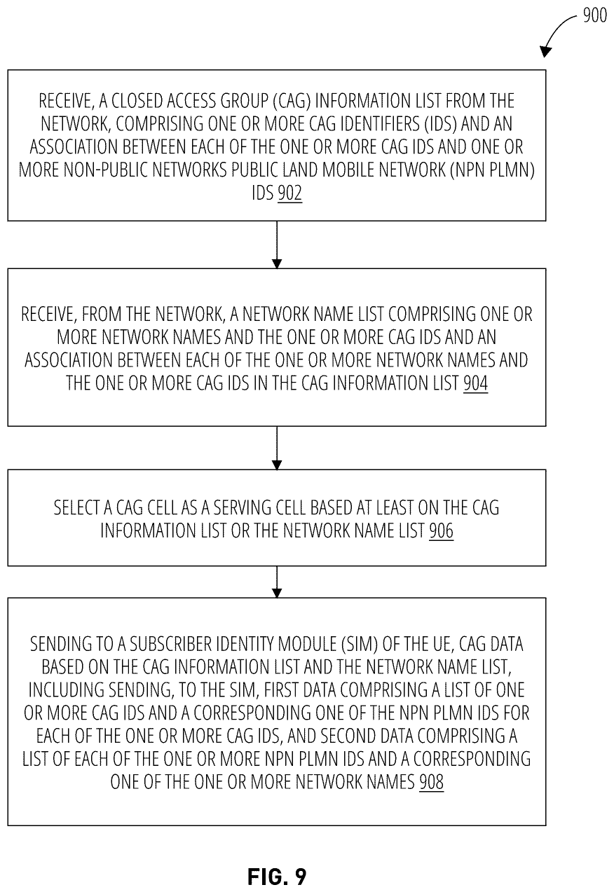

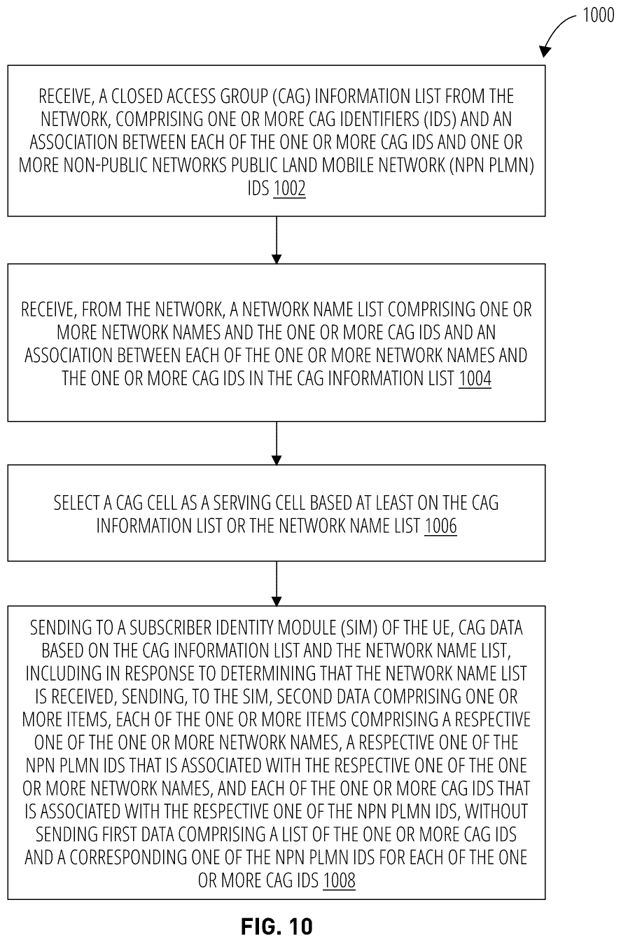

Method 700 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 700 may be performed by a UE that is in communication with a network (e.g., a 5G network) as described in other sections. Some of the operations described with respect to method 700 may correspond to operations described in other sections such as, for example, with respect to FIG. 6, FIG. 8, FIG. 9, and FIG. 10.

The method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented.

The method includes receiving, a closed access group (CAG) information list from the network, comprising one or more CAG identifiers (IDs) and an association between each of the one or more CAG IDs and one or more non-public networks public land mobile network (NPN PLMN) IDs at block 702. The one or more CAG IDs and NPN PLMN IDs may be received over SIB #1. The one or more CAG IDs and associated NPN PLMN IDs received may be summarized by the table 1 below:

TABLE 1
Description

NPN PLMN ID#1 (e.g., MCC + MCN)
CAG ID#1
CAG ID#2
. . .
CAG ID#last
NPN PLMN ID#2
CAG ID#1
CAG ID#2
CAG ID#3
. . .
CAG ID#last
. . .
NPN PLMN ID#last
CAG ID#1
. . .
CAG ID#last

The method includes receiving, from the network, a network name list comprising one or more network names and the one or more CAG IDs and an association between each of the one or more network names and the one or more CAG IDs in the CAG information list at block 704. The network name list may be received over SIB #10 from the network.

The network name list may be summarized as below:

TABLE 2
Description

NPN PLMN ID#1 (e.g., MCC + MCN)
Network name #1
. . .
NPN PLMN ID#last
Network name #last

Each network name may correspond to one of the NPN PLMN IDs in the SIB #10 message (e.g., on a one to one basis). Further, each of the NPN PLMN IDs in the SIB #10 message may be the same as one of the NPN PLMN IDs in the SIB #1 message. The UE may map the network names to CAG IDs grouped to the corresponding NPN PLMN ID.

The method includes selecting a CAG cell as a serving cell based at least on the CAG information list or the network name list at block 706. CAG cell selection may be performed based on one or more conditions such as network resources, configuration of the UE by the network, bandwidth, the UE location, signal strength, accessibility to a given CAG cell by the UE, or other condition. Details regarding how a UE selects a CAG cell may vary.

The method includes sending to a subscriber identity module (SIM) of the UE, CAG data based on the CAG information list and the network name list at block 708. In some aspects, the CAG data may include non-redundant mapping of each of the network names, the corresponding NPN PLMN IDs, and the CAG IDs associated with the NPN PLMN IDs.

In an example, at block 708, the UE may determine that the amount of CAG data generated from the received data at blocks 702 and 704 is above a given threshold (e.g., a data size threshold) for sending to the SIM. In such a case, the UE may prioritize data of the selected CAG cell and truncate the data to fit. When truncation of CAG information is done, the UE prioritizes the CAG information of the currently selected NPN PLMN ID and/or CAG cell and includes it in the terminal response or envelope command to the SIM before the remaining CAG data. The UE encodes the remaining CAG data into the remaining available bits and sends the CAG data (with the prioritized selected CAG cell and remaining data) to the SIM.

For example, the UE may send the selected CAG cell (e.g., the CAG cell ID of the selected CAG cell) and associated NPN PLMN ID in front of additional CAG IDs of the one or more CAG IDs, and truncate a total amount of data (e.g., the remaining CAG data) sent to the SIM to satisfy a threshold data size sent to the SIM. This prioritizes the data associated with the selected CAG cell.

In an example, the UE sends the CAG data to the SIM through a terminal response, in response to a PLI request signaled from the SIM. For example, the SIM may send the PLI request (e.g., 616) to the UE to request that the UE sends the CAG data. The UE may send the terminal response (e.g., 618) to the SIM with the CAG data.

Additionally, or alternatively, the UE may send the CAG data to the SIM through an envelope command, in response to detecting an event associated with a change in the CAG IDs. For example, the SIM may send an envelope event configuration command 616 to the UE that configures the UE to respond with CAG data when one or more conditions are satisfied, such as in response to the UE receiving the CAG info list and network name list, or in response to a change in any of the CAG info list or network name list, or in response to when the UE selects a CAG cell, or any of combination thereof.

In some examples, the UE may send this CAG data to the SIM only if the UE selects a CAG cell. The UE may send the CAG data to the SIM in response to the UE selecting the CAG cell. Similarly, in response to the UE not selecting the CAG cell to camp on, the UE does not send the CAG data to the SIM. In either case, the UE may send other information to the SIM like whether or not the UE is camped on or has selected a CAG cell to camp on. After a UE selects a CAG cell, the UE may initiate one or more connection procedures to camp on that CAG cell, assuming that the UE has the required credentials to access the CAG cell.

When UE sends the information to the SIM (e.g., via terminal response or envelope command), the SIM can perform various network functions with this CAG data. For example, the SIM may include a Sim Toolkit (STK) applet that uses this information to configure or reconfigure the sim. The applet may also store the received data within the SIM for processing. The SIM may also send the CAG data to a home carrier network for diagnostic or for future re-configurations, which may be based on operator decision. The function of the SIM and applet with respect to the received CAG data can vary from network operator to operator.

FIG. 8 illustrates an example method for improving CAG cell selection STK commands with ordered network names, according to an aspect. The method may be performed by processing logic of a UE, which may be coupled to a transceiver, where the processor may execute instructions stored on computer-readable memory to perform the method described. The performed by user equipment (UE) in communication with a network.

Method 800 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of the method may be performed by a UE that is in communication with a network (e.g., a 5G network) as described in other sections. Some of the operations described with respect to the method may correspond to operations described in other sections such as, for example, with respect to FIG. 6, FIG. 7, FIG. 9, or FIG. 10.

The method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented.

According to some examples, the method includes receiving, a closed access group (CAG) information list from the network, comprising one or more CAG identifiers (IDs) and an association between each of the one or more CAG IDs and one or more non-public networks public land mobile network (NPN PLMN) IDs at block 802.

According to some examples, the method includes receiving, from the network, a network name list comprising one or more network names and the one or more CAG IDs and an association between each of the one or more network names and the one or more CAG IDs in the CAG information list at block 804.

According to some examples, the method includes selecting a CAG cell as a serving cell based at least on the CAG information list or the network name list at block 806.

According to some examples, the method includes sending to a subscriber identity module (SIM) of the UE, CAG data based on the CAG information list and the network name list, including sending, to the SIM, first data comprising a list of the one or more CAG IDs and a corresponding one of the NPN PLMN IDs, and second data comprising, a list of one of the one or more network names in a same order as an order of the NPN PLMN IDs listed in the first data, wherein each of the one or more NPN PLMN IDs correspond to one of the one or more network names at block 808.

Table 1 (shown above) shows an example of the first data, the first data may include the NPN PLMN ID associated with the list of CAG IDs. First data may, in any of the examples described, be referred to as CAG information list 8.148. Similarly, second data may be referred to as a network name list 8.149.

In another example, the first data may include a ‘CAG information list’ where each list item in the CAG information list includes a CAG ID and their associated NPN PLMN ID, as shown below.

TABLE 3

| Bytes | Description | Length |
|---|---|---|
| 1 | CAG information list tag | 1 |
| 2 | length | 1 |
| 3 to X + 2 | CAG information list | X |

Second data may include a list of the network names in order within CAG ID human readable network name per the PLMN list (e.g., received at block 802). The UE may prepare the CAG data so that the second data does not comprise any of the one or more CAG IDs included in the first data, thereby reducing redundancy in data.

The second data may comprise, for each of the one or more network names, a network name tag, a respective length associated with the respective network name tag, and the respective network name, without additional information. The second data may just list the network names broadcast and received from the network (without respective CAG IDs) in the same order in which the NPN PLMN IDs were indicated in the “CAG Information List.” in Table 3 or Table 1. If for a PLMN ID indicated in the CAG information list, there is no network name broadcast, the UE may include the TAG (e.g., a network name tag), but also set the corresponding length to 0. The table 4 below shows an example of second data which may be generate by the UE and sent to the SIM.

TABLE 4
Description

1st network name tag
length
1st network name
2nd network name tag
length
2nd network name
. . .
last network name tag
length
last network name

It should be understood that in this method and in other methods described, the data sent to SIM can include additional data such as, for example, CAG cell selection status, command details, device entities, eve or other CAG-related or non-CAG-related data, that may be prior to, between, or after the first data and second data. For example, in the case of a terminal response, the first data and second data may be packaged and sent by the UE as ‘local information’ which may be preceded by command details, device entities and/or a result. In the case of an event download envelope response, the first data may be packaged as ‘CAG information list’ and the second data may be packaged as ‘CAG ID human readable network name per CAG ID list’, and the first and second data may be preceded by an ‘event download tag’, ‘length’, ‘event list’, ‘device entities’, ‘access technologies’, and/or ‘CAG cell selection status’.

FIG. 9 illustrates an example method performed for improving CAG cell selection STK commands with paired network names and NPN PLMN IDs according to an aspect. The method 900 may be performed by processing logic of a UE, which may be coupled to a transceiver, where the processor may execute instructions stored on computer-readable memory to perform the method described. The performed by user equipment (UE) in communication with a network.

Method 900 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of the method may be performed by a UE that is in communication with a network (e.g., a 5G network) as described in other sections. Some of the operations described with respect to the method may correspond to operations described in other sections such as, for example, with respect to FIG. 6, FIG. 7, FIG. 8, or FIG. 10.

The method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented.

According to some examples, the method includes receiving, a closed access group (CAG) information list from the network, comprising one or more CAG identifiers (IDs) and an association between each of the one or more CAG IDs and one or more non-public networks public land mobile network (NPN PLMN) IDs at block 902.

According to some examples, the method includes receiving, from the network, a network name list comprising one or more network names and the one or more CAG IDs and an association between each of the one or more network names and the one or more CAG IDs in the CAG information list at block 904.

According to some examples, the method includes selecting a CAG cell as a serving cell based at least on the CAG information list or the network name list at block 906.

According to some examples, the method includes sending to a subscriber identity module (SIM) of the UE, CAG data based on the CAG information list and the network name list, including sending, to the SIM, first data comprising a list of one or more CAG IDs and a corresponding one of the NPN PLMN IDs for each of the one or more CAG IDs, and second data comprising a list of each of the one or more NPN PLMN IDs and a corresponding one of the one or more network names at block 908.

The UE may generate the first data as described with respect to method 700 and 800. The second data may comprise each of the one or more NPN PLMN IDs paired with the one or more network names. Each pair may comprise a network name tag, a length associated with the network name, the respective NPN PLMN ID, and the respective network name. See, for example, Table 5 below.

In the second data, instead of CAG IDs in the CAG ID network name list of the second data, the NPN PLMN ID and the corresponding network name is indicated. For a case where there is no network name broadcast for a given NPN PLMN ID, the UE may indicate the network name length as zero. The table below shows an example of the second data.

TABLE 5
Description

1st NPN PLMN ID network name tag
length
1st NPN PLMN ID
1st network name
2nd NPN PLMN ID network name tag
length
2nd NPN PLMN ID
2nd network name
. . .
last NPN PLMN ID network name tag
length
last NPN PLMN ID
last network name

FIG. 10 illustrates an example method performed for improving CAG cell selection STK commands with tag-based indication of CAG ID presentation, according to an aspect. The method 1000 may be performed by processing logic of a UE, which may be coupled to a transceiver, where the processor may execute instructions stored on computer-readable memory to perform the method described. The performed by user equipment (UE) in communication with a network.

Method 1000 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of the method may be performed by a UE that is in communication with a network (e.g., a 5G network) as described in other sections. Some of the operations described with respect to the method may correspond to operations described in other sections such as, for example, with respect to any of FIG. 6-FIG. 9.

The method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented.

According to some examples, the method includes receiving, a closed access group (CAG) information list from the network, comprising one or more CAG identifiers (IDs) and an association between each of the one or more CAG IDs and one or more non-public networks public land mobile network (NPN PLMN) IDs at block 1002.

According to some examples, the method includes receiving, from the network, a network name list comprising one or more network names and the one or more CAG IDs and an association between each of the one or more network names and the one or more CAG IDs in the CAG information list at block 1004.

According to some examples, the method includes selecting a CAG cell as a serving cell based at least on the CAG information list or the network name list at block 1006.

According to some examples, the method includes sending to a subscriber identity module (SIM) of the UE, CAG data based on the CAG information list and the network name list, including in response to determining that the network name list is received, sending, to the SIM, second data comprising one or more items, each of the one or more items comprising a respective one of the one or more network names, a respective one of the NPN PLMN IDs that is associated with the respective one of the one or more network names, and each of the one or more CAG IDs that is associated with the respective one of the NPN PLMN IDs, without sending first data (as described in other sections) comprising a list of the one or more CAG IDs and a corresponding one of the NPN PLMN IDs for each of the one or more CAG IDs at block 1008.

As described, every individual entry of CAG Information list encoding may include an unwanted byte and holds no meaning for PLI/Envelope CAG selection for first data (e.g., 8.148). To resolve the concern, coding of CAG information list 8.148 is modified (Byte 3+X+2). The information relating to if the CAG IDs are represented as a range or individually listed can be differentiated by a first CAG ID for individual listing and a second CAG ID for a CAG ID range, instead of wasting this one byte multiple times. CAG ID tag ‘X’ may represent “individual listing of CAG IDs”, and CAG ID tag ‘Y’ may represent “CAG-ID range”.

For example, sending the second data may include sending a first item of the one or more items, the first item comprising a first tag associated with a single CAG ID, a first length associated with a single CAG ID, a first of the one or more NPN PLMN IDs, a single one of the one or more CAG IDs that is associated with the first of the one or more NPN PLMN IDs, and one of the one or more network names that is associated with the first of the one or more NPN PLMN IDs.

Similarly, sending the second data may include sending a second item of the one or more items, the second item comprising a second tag associated with a range of CAG IDs, a second length associated with the range of CAG IDs, a second of the one or more NPN PLMN IDs that is associated with the range of CAG IDs, a first and second of the one or more CAG IDs that indicate the range of CAG IDs that are associated with the second of the one or more NPN PLMN IDS, and a second of the one or more network names that is associated with the second of the one or more NPN PLMN IDs.

The UE may list the network name and corresponding NPN PLMN ID in the received order within the second data as indicated in the table below. In the case of a range, the CAG ID network name tag may be a first value (e.g., ‘80’) and in the case of an individual CAG ID, the network name tag may be a second value (e.g., ‘81’) different from the first value. Thus, the UE may package the second data in a compact but flexible manner, choosing to list individual CAG IDs, a range of CAG IDs, or both in the second data. Further, the UE may encode a first length for individual CAG IDs, and a second length that accommodates for the additional size of a range of CAG IDs.

TABLE 6

| | | | Length |
|---|---|---|---|
| Description | Value | M/O | (bytes) |
| 1st CAG ID network name tag | ‘80’ or ‘81’ | M | 1 |
| length | 4 + 3 + A1 or | M | 1 |
| | 8 + 3 + A1 | | |
| NPN PLMN ID | | M | 3 |
| 1st CAG ID or 1st CAG ID range | | M | 4 or 8 |
| 1st CAG ID network name | | M | A1 |
| 2nd CAG ID network name tag | ‘80’ or ‘81’ | M | 1 |
| length | 4 + 3 + A1 or | M | 1 |
| | 8 + 3 + A1 | | |
| NPN PLMN ID | | M | 3 |
| 2nd CAG ID or 2nd CAG ID range | | M | 4 or 8 |
| 2nd CAG ID network name | | M | A2 |
| . . . | | | |
| last CAG ID network name tag | ‘80’ or ‘81’ | O | 1 |
| length | 4 + 3 + A1 or | O | 1 |
| | 8 + 3 + A1 | | |
| NPN PLMN ID | | M | 3 |
| last CAG ID or last CAG ID range | | O | 4 or 8 |
| last CAG ID network name | | O | A2 |

In another alternative, the UE may use a single encoding to indicate the broadcast CAG information including the network name, instead of a “CAG Information List” and “CAG ID Human Readable Network Name (HRNN) List”. The UE may encode the second data as indicated in the below table:

TABLE 7
Description

PLMN Tag
PLMN length
NPN PLMN ID
CAG ID Tag
length of CAG ID contents
CAG ID 1
CAG ID 2
. . .
CAG ID m
network name tag
length of network name
network name

In other words, the UE may send just the second data and not the first data, for example, when the network name list is received.

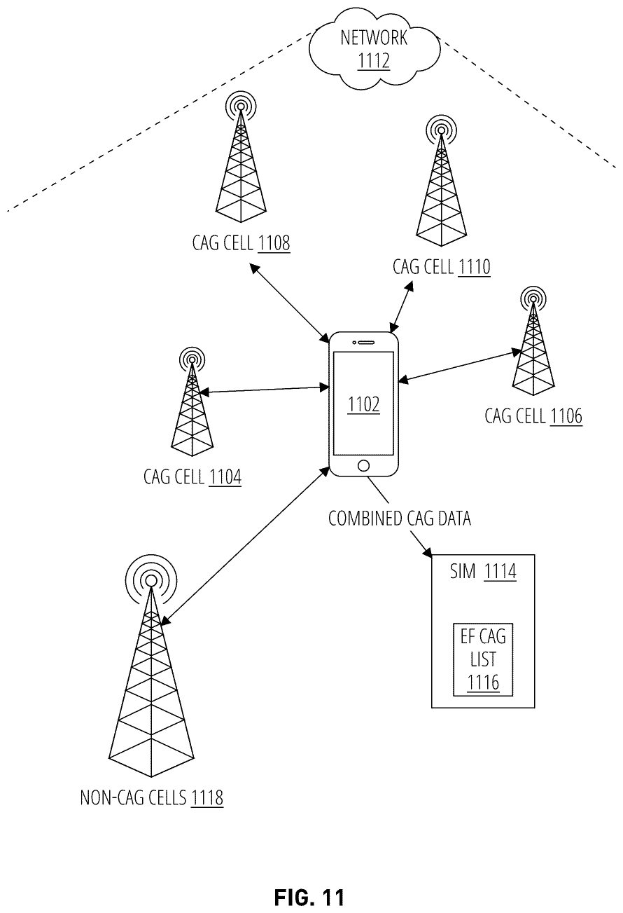

FIG. 11 shows an example of a UE and network with respect to CAG cell selection, according to an aspect. A UE 1102 may communicate with a network 1112. The network 1112 may comprise one or more closed access group (CAG) cells such as 1104, 1106, 1108, and 1110. The network may further comprise one or more non-CAG cells (e.g., 1118). Network concepts (e.g., CAG, PLMN ID, PNI NPN, network name, etc.) described in other sections may apply to FIG. 11.

In an aspect, the UE 1102 may detect all neighboring CAG cells in network 1112 and provide the CAG data for these neighboring CAG cells to SIM 1114. This CAG data may include the CAG cell that is ultimately selected, but it also includes non-selected CAG cells. Thus, the SIM 1114 may process and store additional CAG context of the UE 1102, which may be used by the UE to better select a cell to camp on under different scenarios.

For example, UE 1102 may detect one or more neighboring CAG cells (e.g., 1104, 1106, 1108, and 1110) based on receiving from each of the one or more neighboring CAG cells, a CAG list (e.g., 612). As described in other sections, this CAG list may include one or more CAG identifiers (IDs) and an association between each of the one or more CAG IDs and one or more non-public networks public land mobile network (NPN PLMN) IDs. A neighboring CAG cell may be a CAG cell that satisfies a threshold (e.g., a signal strength threshold, a distance threshold, or other threshold indicating the ability of the UE to connect with that CAG cell).

UE 1102 may receive from each of the one or more detected neighboring CAG cells, a network name list (e.g., 614) that includes one or more network names and the one or more CAG IDs, and an association between each of the one or more network names and the one or more CAG IDs in the CAG information list.

The UE may send to SIM 1114 of the UE, CAG data that is generated based on the CAG information list and the network name list of each of the detected one or more CAG cells. It may combine the received data (e.g., 612, 614) from each of the CAG cells into the CAG data and send the combined CAG data to the SIM 1114.

The sending of the CAG data from the UE 1102 to SIM 1114 may be performed in response to a change to the CAG information list of any of the one or more detected neighboring CAG cells.

Generally, the SIM 1114 may store a SIM CAG list 1116 based on the CAG data. In some scenarios that may be outside the scope of this disclosure, this SIM CAG list 1116 may be subsequently used by the UE for cell selection of a CAG cell. The SIM CAG list 1116 may be stored as an elementary file (EF) within the SIM 1114. This EF may be referred to as ‘EF_CAG’. The SIM 1114 may process the CAG data and store each of the CAG IDs in the CAG data according to their respective PLMN IDs. As described, CAG IDs may be listed and stored individually or as a range. The SIM CAG list may represent an allowed CAG list for the UE to camp on.

The UE 1102 may send the CAG data to the SIM of the UE through a terminal response using terminal or an envelope command. For example, in response to receiving a provide local information (PLI) CAG information list request signaled from the SIM, the UE may send the CAG data to the SIM through the terminal. Similarly, in response to an event (e.g., a change or update any of the CAG information received from CAG cells), the UE may send the CAG data to the SIM through the envelope command. The UE may send this CAG data irrespective of whether of the UE's registration status. For example, the UE may send this CAG data to SIM 1114 when it is registered to a cell, or when it is not registered to a cell. In such a manner, the SIM 1114 may beneficially be updated with which CAG cells are neighboring a UE so that the SIM may be used in the future for CAG cell selection.

In an example, in response to sending the CAG data when the UE is not registered to any of the one or more detected neighboring CAG cells, the UE may include an indicator in the CAG data, that the UE is registered to a non-CAG cell. Generally, the SIM card may process and/or store all the CAT data sent from the UE. For example, the SIM may store this indicator or perform other operations with this indicator that the UE is registered to one of non-CAG cells 1118 to better understand why the UE has not selected or registered to a CAG cell.

The UE may, in response to when the UE is not registered to any of the detected neighboring CAG cells (e.g., 1104, 1106, 1108, 1110), include in the combined CAG data, a reason that the UE was rejected from one of the detected neighboring CAG cells. The reason may be encoded as an agreed upon enumerated value that indicates to the SIM 1114 why the UE was rejected when it tried to register to one of the neighboring CAG cells. The UE may include, in the combined CAG data, an indicator of a CAG ID, PLMN ID, or network name (e.g., HRNN), that corresponds to the CAG cell that rejected the UE, or that correspond to the CAG cell that the UE is camped on, or both. In this manner, the network may properly identify the rejecting CAG cell, the camped CAG cell, or both.

In the combined CAG data, if the UE selects one of the CAG cells, the UE may place this selected CAG cell as the first entry in a CAG information list. Subsequent entries in the CAG information list may be associated with unselected neighboring CAG cells.

In some cases (outside the scope of the present disclosure), the UE may determine that access to the network 1112 may only be achieved through CAG access. In such a case, the UE may include a ‘CAG only’ bit in the combined CAG data that indicates if the UE is only allowed to access the network through CAG cell access. The UE may set the ‘CAG only’ bit based on a CAG only indication received from the network. For example, the network 1112 may send a registration accept message to the UE that indicates that network access is ‘CAG only’. In response, the UE may set the ‘CAG only’ bit with an agreed upon value to indicate to the SIM 1114 whether or not the UE must register with a CAG cell to connect to the network 1112 (at least in a specific RAT, e.g., in a 5G network).

The UE may include in the combined CAG data, an ignore field that, when set, indicates to the SIM 1114 whether or not the SIM is to ignore the ‘CAG only’ bit also in the combined CAG data. In an example, the UE may set the ignore field to indicate to the SIM to ignore the CAG only bit in response to not receiving the CAG only indication. Conversely, if the CAG only indication is received by the UE 1102 (e.g., from the network), the UE may set the ignore field to indicate to the SIM that the ‘CAG only’ field is valid and should not be ignored.

Alternatively, instead of an ignore field, the UE may omit a field (e.g., the entire byte field) including the CAG only bit and the ignore field in the CAG data altogether. In some examples, this may be in response to not receiving the CAG only indication (e.g., from the network 1112).

Portions of what is described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMS, EPROMS, EEPROMs, magnetic or optical cards, or any type of media suitable for storing electronic instructions, and each coupled to a computer system bus.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

In any of the examples described, a processor may include a baseband processor (also known as baseband radio processor, BP, or BBP) is a device (a chip or part of a chip) in a network interface that manages radio functions, such as communicating (e.g., TX and RX) over an antenna.

An article of manufacture may be used to store program code. An article of manufacture that stores program code may be embodied as, but is not limited to, one or more memories (e.g., one or more flash memories, random access memories (static, dynamic, or other)), optical disks, CD-ROMs, DVD ROMs, EPROMS, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “transmitting”, “sending”, “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing discussion merely describes some exemplary aspects of the present invention. One skilled in the art will readily recognize from such discussion, the accompanying drawings and the claims that various modifications can be made without departing from the spirit and scope of the invention.

What is claimed is:

1. A method, performed by a user equipment that is in communication with a network, comprising:
receiving, a closed access group (CAG) information list from the network, comprising one or more CAG identifiers (IDs) and an association between each of the one or more CAG IDs and one or more non-public networks public land mobile network (NPN PLMN) IDs;
receiving, from the network, a network name list comprising one or more network names and the one or more CAG IDs and an association between each of the one or more network names and the one or more CAG IDs in the CAG information list;
selecting a CAG cell as a serving cell based at least on the CAG information list or the network name list; and
sending to a subscriber identity module (SIM) of the UE, CAG data based on the CAG information list and the network name list.

2. The method of claim 1, wherein sending to the SIM comprises: sending, to the SIM, first data comprising a list of the one or more CAG IDs and a corresponding one of the NPN PLMN IDs, and second data comprising, a list of one of the one or more network names in a same order as an order of the NPN PLMN IDs listed in the first data, wherein each of the one or more NPN PLMN IDs correspond to one of the one or more network names.

3. The method of claim 2, wherein the second data does not comprise any of the one or more CAG IDs.

4. The method of claim 2, wherein the second data comprises, for each of the one or more network names, a network name tag, a respective length associated with the respective network name tag, and the respective network name, without additional information.

5. The method of claim 1, wherein sending to the SIM comprises: sending, to the SIM, first data comprising a list of one or more CAG IDs and a corresponding one of the NPN PLMN IDs for each of the one or more CAG IDs, and second data comprising a list of each of the one or more NPN PLMN IDs and a corresponding one of the one or more network names.

6. The method of claim 5, wherein the second data comprises each of the one or more NPN PLMN IDs paired with the one or more network names, each pair comprising a network name tag, a length associated with the network name, the respective NPN PLMN ID, and the respective network name.

7. The method of claim 1, wherein sending to the SIM comprises: in response to determining that the network name list is received, sending, to the SIM, second data comprising one or more items, each of the one or more items comprising a respective one of the one or more network names, a respective one of the NPN PLMN IDs that is associated with the respective one of the one or more network names, and each of the one or more CAG IDs that is associated with the respective one of the NPN PLMN IDs, without sending first data comprising a list of the one or more CAG IDs and a corresponding one of the NPN PLMN IDs for each of the one or more CAG IDs.

8. The method of claim 7, wherein sending the second data comprises sending a first item of the one or more items, the first item comprising a first tag associated with a single CAG ID, a first length associated with a single CAG ID, a first of the one or more NPN PLMN IDs, a single one of the one or more CAG IDs that is associated with the first of the one or more NPN PLMN IDs, and one of the one or more network names that is associated with the first of the one or more NPN PLMN IDs.

9. The method of claim 8, wherein sending the second data comprises sending a second item of the one or more items, the second item comprising a second tag associated with a range of CAG IDs, a second length associated with the range of CAG IDs, a second of the one or more NPN PLMN IDs that is associated with the range of CAG IDs, a first and second of the one or more CAG IDs that indicate the range of CAG IDs that are associated with the second of the one or more NPN PLMN IDS, and a second of the one or more network names that is associated with the second of the one or more NPN PLMN IDs.

10. The method of claim 1, wherein sending to the SIM comprises sending the selected CAG cell and associated NPN PLMN IDs in front of additional CAG IDs of the one or more CAG IDs, and truncating a total amount of data sent to the SIM to satisfy a threshold data size to the SIM.

11. The method of claim 1, wherein sending to the SIM is performed by the UE through a terminal response, in response to a provide local information (PLI) request signaled from the SIM.

12. The method of claim 1, wherein sending to the SIM is performed by the UE through an envelope command in response to detecting an event associated with a change in the CAG IDs.

13. The method of claim 1, wherein in response to the UE not selecting the CAG cell to camp on, the UE does not send the CAG data to the SIM.

14. The method of claim 1, further comprising:
detecting one or more neighboring CAG cells of the UE; and
including, in the CAG data that is sent to the SIM of the UE, a second CAG information list and second network names that are associated with each of the one or more detected neighboring CAG cells.

15. The method of claim 14, wherein sending the CAG data to the SIM of the UE is performed in response to a change to the CAG information list or to the second CAG information list of any of the one or more detected neighboring CAG cells.

16. The method of claim 14, wherein the SIM card stores a SIM CAG list based on the CAG data, and wherein the UE uses the SIM CAG list for cell selection.

17. The method of claim 14, wherein sending the CAG data to the SIM of the UE is performed through a terminal response in response to receiving a provide local information (PLI) CAG information list request signaled from the SIM, or through an envelope command in response to an event CAG cell selection, when the UE is registered to a cell of the network.

18. The method of claim 14, wherein sending the CAG data to the SIM of the UE is performed through a terminal response in response to receiving a provide local information (PLI) CAG information list request signaled from the SIM, or through an envelope command in response to an event CAG cell selection, when the UE is not registered to a cell of the network.

19. The method of claim 14, wherein in response to sending the CAG data when the UE is not registered to any one of: the CAG cell or the one or more detected neighboring CAG cells, including an indicator in the CAG data, that the UE is registered to a non-CAG cell.

20. The method of claim 19, wherein in response to sending the CAG data when the UE is not registered to any one of: the CAG cell or the one or more detected neighboring CAG cells, including in the CAG data, a reason that the UE was rejected from the CAG cell or from one of the one or more detected neighboring CAG cells.

21. The method of claim 20, further comprising: including an indicator in the CAG data, of a CAG ID, PLMN ID, network name, that corresponds to one of the CAG cell or the one or more detected neighboring CAG cells that rejected the UE.

22. The method of claim 14, wherein a first entry in a CAG information list provided in the CAG data is associated with the CAG cell that is selected, and one or more subsequent entries in the CAG information list are associated with the one or more detected neighboring CAG cells that are not selected.

23. The method of claim 14, wherein the UE includes a CAG only bit in CAG data that indicates if the UE is only allowed to access 5G network through CAG cell access, and wherein the UE sets the CAG only bit according to a CAG only indication received in a registration accept message received from the network.

24. The method of claim 23, wherein the UE includes and sets an ignore field in the CAG data to indicate whether or not to the SIM to ignore the CAG only bit.

25. The method of claim 23, wherein the UE omits a field including the CAG only bit in response to not receiving the CAG only indication.

26. A user equipment (UE) device that is in communication with a network, comprising a processor that is configured to:
receive, a closed access group (CAG) information list from the network, comprising one or more CAG identifiers (IDs) and an association between each of the one or more CAG IDs and one or more non-public networks public land mobile network (NPN PLMN) IDs;
receive, from the network, a network name list comprising one or more network names and the one or more CAG IDs and an association between each of the one or more network names and the one or more CAG IDs in the CAG information list;
select a CAG cell as a serving cell based at least on the CAG information list or the network name list; and
send, to a subscriber identity module (SIM) that is in communication with the UE, CAG data based on the CAG information list and the network name list.

27. The UE device of claim 26, wherein to send to the SIM the CAG data comprises: sending, to the SIM, first data comprising a list of the one or more CAG IDs and a corresponding one of the NPN PLMN IDs, and second data comprising, a list of one of the one or more network names in a same order as an order of the NPN PLMN IDs listed in the first data, wherein each of the one or more NPN PLMN IDs correspond to one of the one or more network names.

28. The UE device of claim 27, wherein the second data does not comprise any of the one or more CAG IDs.

29. The UE device of claim 27, wherein the second data comprises, for each of the one or more network names, a network name tag, a respective length associated with the respective network name tag, and the respective network name, without additional information.

30. The UE device of claim 26, wherein to send to the SIM the CAG data comprises: sending, to the SIM, first data comprising a list of one or more CAG IDs and a corresponding one of the NPN PLMN IDs for each of the one or more CAG IDs, and second data comprising a list of each of the one or more NPN PLMN IDs and a corresponding one of the one or more network names.

31. The UE device of claim 30, wherein the second data comprises each of the one or more NPN PLMN IDs paired with the one or more network names, each pair comprising a network name tag, a length associated with the network name, the respective NPN PLMN ID, and the respective network name.

32. The UE device of claim 26, wherein to send to the SIM the CAG data comprises: in response to determining that the network name list is received, sending, to the SIM, second data comprising one or more items, each of the one or more items comprising a respective one of the one or more network names, a respective one of the NPN PLMN IDs that is associated with the respective one of the one or more network names, and each of the one or more CAG IDs that is associated with the respective one of the NPN PLMN IDs, without sending first data comprising a list of the one or more CAG IDs and a corresponding one of the NPN PLMN IDs for each of the one or more CAG IDs.

33. The UE device of claim 32, wherein to send the second data comprises sending a first item of the one or more items, the first item comprising a first tag associated with a single CAG ID, a first length associated with a single CAG ID, a first of the one or more NPN PLMN IDs, a single one of the one or more CAG IDs that is associated with the first of the one or more NPN PLMN IDs, and one of the one or more network names that is associated with the first of the one or more NPN PLMN IDs.

34. The UE device of claim 33, wherein to send the second data comprises sending a second item of the one or more items, the second item comprising a second tag associated with a range of CAG IDs, a second length associated with the range of CAG IDs, a second of the one or more NPN PLMN IDs that is associated with the range of CAG IDs, a first and second of the one or more CAG IDs that indicate the range of CAG IDs that are associated with the second of the one or more NPN PLMN IDS, and a second of the one or more network names that is associated with the second of the one or more NPN PLMN IDs.

35. The UE device of claim 26, wherein to send to the SIM the CAG data comprises sending the selected CAG cell and associated NPN PLMN IDs in front of additional CAG IDs of the one or more CAG IDs, and truncating a total amount of data sent to the SIM to satisfy a threshold data size to the SIM.

36. The UE device of claim 26, wherein to send to the SIM the CAG data is performed by the UE through a terminal response, in response to a provide local information (PLI) request signaled from the SIM.

37. The UE device of claim 26, wherein to send to the SIM the CAG data is performed by the UE through an envelope command in response to detecting an event associated with a change in the CAG IDs.

38. The UE device of claim 26, wherein in response to the UE not selecting the CAG cell to camp on, the UE does not send the CAG data to the SIM.

39. The UE device of claim 26, further comprising:
detecting one or more neighboring CAG cells of the UE; and
including, in the CAG data that is sent to the SIM of the UE, a second CAG information list and second network names that are associated with each of the one or more detected neighboring CAG cells.

40. The UE device of claim 39, wherein sending the CAG data to the SIM of the UE is performed in response to a change to the CAG information list or to the second CAG information list of any of the one or more detected neighboring CAG cells.

41. The UE device of claim 39, wherein the SIM card stores a SIM CAG list based on the CAG data, and wherein the UE uses the SIM CAG list for cell selection.

42. The UE device of claim 39, wherein sending the CAG data to the SIM of the UE is performed through a terminal response in response to receiving a provide local information (PLI) CAG information list request signaled from the SIM, or through an envelope command in response to an event CAG cell selection, when the UE is registered to a cell of the network.

43. The UE device of claim 39, wherein sending the CAG data to the SIM of the UE is performed through a terminal response in response to receiving a provide local information (PLI) CAG information list request signaled from the SIM, or through an envelope command in response to an event CAG cell selection, when the UE is not registered to a cell of the network.

44. The UE device of claim 39, wherein in response to sending the CAG data when the UE is not registered to any one of: the CAG cell or the one or more detected neighboring CAG cells, including an indicator in the CAG data, that the UE is registered to a non-CAG cell.

45. The UE device of claim 44, wherein in response to sending the CAG data when the UE is not registered to any one of: the CAG cell or the one or more detected neighboring CAG cells, including in the CAG data, a reason that the UE was rejected from the CAG cell or from one of the one or more detected neighboring CAG cells.

46. The UE device of claim 45, further comprising: including an indicator in the CAG data, of a CAG ID, PLMN ID, network name, that corresponds to one of the CAG cell or the one or more detected neighboring CAG cells that rejected the UE.

47. The UE device of claim 39, wherein a first entry in a CAG information list provided in the CAG data is associated with the CAG cell that is selected, and one or more subsequent entries in the CAG information list are associated with the one or more detected neighboring CAG cells that are not selected.

48. The UE device of claim 39, wherein the UE includes a CAG only bit in CAG data that indicates if the UE is only allowed to access 5G network through CAG cell access, and wherein the UE sets the CAG only bit according to a CAG only indication received in a registration accept message received from the network.

49. The UE device of claim 48, wherein the UE includes and sets an ignore field in the CAG data to indicate to the SIM whether or not to ignore the CAG only bit in response to not receiving the CAG only indication.

50. The UE device of claim 48, wherein the UE omits the CAG only bit in the CAG data in response to not receiving the CAG only indication.

51. A non-transitory computer-readable storage medium, the computer-readable storage medium including instructions that when executed by a processing device of a user equipment (UE) that is in communication with a network, cause the processing device to:
receive, a closed access group (CAG) information list from the network, comprising one or more CAG identifiers (IDs) and an association between each of the one or more CAG IDs and one or more non-public networks public land mobile network (NPN PLMN) IDs;
receive, from the network, a network name list comprising one or more network names and the one or more CAG IDs and an association between each of the one or more network names and the one or more CAG IDs in the CAG information list;
select a CAG cell as a serving cell based at least on the CAG information list or the network name list; and send to a subscriber identity module (SIM) of the UE, CAG data based on the CAG information list and the network name list.

52. A method, performed by a user equipment that is in communication with a network, comprising:
detecting one or more neighboring closed access group (CAG) cells based on receiving from each of the one or more neighboring CAG cells, a closed access group (CAG) information list from the network, comprising one or more CAG identifiers (IDs) and an association between each of the one or more CAG IDs and one or more non-public networks public land mobile network (NPN PLMN) IDs;
receiving, from each of the one or more detected neighboring CAG cells, a network name list comprising one or more network names and the one or more CAG IDs and an association between each of the one or more network names and the one or more CAG IDs in the CAG information list; and
sending to a subscriber identity module (SIM) of the UE, CAG data based on the CAG information list and the network name list of each of the detected one or more CAG cells.

53. The method of claim 52, wherein sending the CAG data to the SIM of the UE is performed in response to a change to the CAG information list of any of the one or more detected neighboring CAG cells.

54. The UE device of claim 52, wherein the SIM card stores a SIM CAG list based on the CAG data, and wherein the UE uses the SIM CAG list for cell selection.

55. The UE device of claim 52, wherein sending the CAG data to the SIM of the UE is performed through a terminal response in response to receiving a provide local information (PLI) CAG information list request signaled from the SIM, or through an envelope command in response to an event CAG cell selection, when the UE is registered to a cell of the network.

56. The UE device of claim 52, wherein sending the CAG data to the SIM of the UE is performed through a terminal response in response to receiving a provide local information (PLI) CAG information list request signaled from the SIM, or through an envelope command in response to an event CAG cell selection, when the UE is not registered to a cell of the network.

57. The UE device of claim 52, wherein in response to sending the CAG data when the UE is not registered to any of the one or more detected neighboring CAG cells, including an indicator in the CAG data, that the UE is registered to a non-CAG cell.

58. The UE device of claim 57, wherein in response to sending the CAG data when the UE is not registered to any of the one or more detected neighboring CAG cells, including in the CAG data, a reason that the UE was rejected from one of the one or more detected neighboring CAG cells.

59. The UE device of claim 58, further comprising: including an indicator in the CAG data, of a CAG ID, PLMN ID, network name, that corresponds to one of the one or more detected neighboring CAG cells that rejected the UE.

60. The UE device of claim 52, wherein a first entry in a CAG information list provided in the CAG data is associated with a CAG cell that the UE selected, and one or more subsequent entries in the CAG information list provide in the CAG data are associated with those of the one or more detected neighboring CAG cells that are not selected.

61. The UE device of claim 52, wherein the UE includes a CAG only bit in the CAG data that indicates if the UE is only allowed to access the network through CAG cell access, and wherein the UE sets the CAG only bit according to a CAG only indication received in a registration accept message received from the network.

62. The UE device of claim 61, wherein the UE includes and sets an ignore field in the CAG data to indicate to the SIM whether or not to ignore the CAG only bit in response to not receiving the CAG only indication.

63. The UE device of claim 61, wherein the UE omits the CAG only bit in the CAG data in response to not receiving the CAG only indication.
